(19) United States
(12) Patent Application Publication
(10) Pub. No.: US 2015/0001441 A1
(43) Pub. Date: Jan. 1, 2015

(54) GETTER COMPOSITION, AND ORGANIC EL DISPLAY DEVICE COMPRISING SAME

(71) Applicants: Joon Mo Seo, Uiwang-si (KR); Dong Seon Uh, Uiwang-si (KR); Kwang Won Seo, Uiwang-si (KR)

(72) Inventors: Joon Mo Seo, Uiwang-si (KR); Dong Seon Uh, Uiwang-si (KR); Kwang Won Seo, Uiwang-si (KR)

(73) Assignee: CHEIL INDUSTRIES INC., Gumi-si, Gyeongsangbuk-do (KR)

(21) Appl. No.: 14/367,208

(22) PCT Filed: Aug. 1, 2012
(86) PCT No.: PCT/KR2012/006124

§ 371 Date: Jun. 19, 2014

(30) Foreign Application Priority Data
Dec. 28, 2011 (KR) 10-2011-0145265

(51) Int. Cl. B01J 20/26; B01J 20/04

(52) U.S. Cl. CPC B01J 20/262; B01J 20/041
USPC 252/181.7

(57) ABSTRACT

The present invention relates to a getter composition and to an organic EL display device comprising same. More specifically, the present invention relates to: a getter composition comprising a hygroscopic agent and a silicone copolymer having one or more functional groups selected from the group consisting of the carboxylic acid group and the polyalkylene oxide group; and a display device comprising same.

### TECHNICAL FIELD

The present invention relates to a getter composition and an organic EL display device including the same. More specifically, the present invention relates to a getter composition which has a high moisture absorption rate, high moisture absorption capacity and high dimensional stability at high temperature and high humidity, is capable of controlling fluidity during dispensing and vacuum lamination processes, causing no dark spot upon application to organic devices, and is capable of providing organic devices having high reliability at high temperature and high humidity, and a display device including the same.

### BACKGROUND ART

Flat panel displays or thin layer displays such as plasma display panels, liquid crystal displays, inorganic light emitting diodes, field emission displays and organic electronic electroluminescent devices can be deteriorated in properties due to exposure to moisture. Accordingly, in order to inhibit corrosion such as dark spots and the like by absorbing moisture penetrated through a sealant before the moisture arrives at the organic device, it is necessary to dispose a getter within the display. In this regard, in order for a substance to be used as a getter, the substance must have high moisture absorption capacity and high moisture absorption rate.

Generally, after an element is mounted on a substrate, a getter is deposited through a dispensing process, followed by deposition of a liquid phase sealant or a solid phase encapsulating sheet onto the getter, and is then subjected to vacuum lamination and UV or heat curing. In the dispensing process, the getter must be deposited to a uniform thickness on the substrate such that lines are not disconnected. Vacuum lamination is performed under reduced pressure and the getter must be prevented from dripping down onto an element surface after deposition of the getter. In addition, it is necessary to prevent the getter from being suctioned into the element by negative pressure. Further, upon curing, it is necessary to prevent formation of dark spots due to volatile materials in the getter.

Silicone copolymers typically used as the getter in the art suffer from a problem that the copolymers are likely to be suctioned into an element due to low viscosity and low surface tension, thereby causing dark spots after heat curing.

### DISCLOSURE

### Technical Problem

It is an aspect of the present invention to provide a getter composition having a high moisture absorption capacity, high moisture absorption rate and high dimensional stability at high temperature and high humidity.

It is another aspect of the present invention to provide a getter composition capable of controlling fluidity in dispensing and vacuum lamination processes.

It is a further aspect of the present invention to provide a getter composition causing no dark spot upon application to organic devices and capable of providing organic devices having high reliability at high temperature and high humidity.

It is yet another aspect of the present invention to provide an organic EL display device including the getter composition.

### Technical Solution

One aspect of the present invention provides a getter composition including a silicone copolymer having at least one functional group selected from the group consisting of a carboxylic acid group and a polyalkylene oxide group, and a hygroscopic agent.

Another aspect of the present invention provides an organic EL display device including the getter composition.

### Advantageous Effects

The present invention provides a getter composition having a high moisture absorption capacity, high moisture absorption rate and high dimensional stability at high temperature and high humidity. In addition, the present invention provides a getter composition capable of controlling fluidity during the dispensing and vacuum lamination processes. Further, the present invention provides a getter composition causing no dark spots upon application to organic devices and capable of providing organic devices having high reliability at high temperature and high humidity. The present invention also provides an organic EL display device including the getter composition.

### Best Mode

According to one embodiment of the invention, a getter composition may have a moisture absorption rate of about 10% or more as calculated by Equation 1:

$$Moisture absorption rate ( \% ) = \frac{( B - A )}{A} \times 100 ,$$

wherein A is an initial weight of the getter composition and B is the weight of the getter composition measured after storing at 25° C. and 60% relative humidity for 500 days. Within this range, the getter composition can be employed in an organic EL display device, thereby providing high moisture absorption rate and high absorption capacity. Preferably, the moisture absorption rate ranges from about 11% to about 20%, more preferably from about 16% to about 18%.

The getter composition may be a non-curable composition. A typical getter composition requires thermosetting when applied to organic EL elements. As a result, the typical getter composition has a problem that dark spots can occur due to volatile materials. Conversely, the getter composition of the present invention is a non-curable type and does not require curing procedures, and thus does not cause dark spots when applied to organic EL elements.

The getter composition has a viscosity at about 25° C. from about 5,000 cps to about 20,000 cps, preferably from about 7,000 cps to about 18,000 cps, more preferably from about 10,000 cps to about 15,000 cps. Within this range, the getter composition can prevent a silicone copolymer therein from being not suctioned into an OLED upon vacuum lamination after dispensing, can contain a large amount of hygroscopic agent, can prevent a problem of discharge in the dispensing process, and allows easy adjustment of the thickness and width of lines. The viscosity may be measured by a Brookfield viscometer DV-II+ at about 5 rpm and 25° C., without being limited thereto.

The getter composition is a liquid having an appropriate viscosity at room temperature. Thus, the getter composition is not required to include a separate organic solvent. As a result, a solid hygroscopic agent has good compatibility with other components except for the hygroscopic agent in the getter composition, which permits application of the getter composition to organic EL elements.

The getter composition may have a difference in moisture absorption rate (h1−ho) of about 1% or more, which is a difference between a measured value (h1) of moisture absorption rate and a calculated value (h0) of moisture absorption rate, as calculated by Equation 2:

Difference in moisture absorption rate=h1−h0,

wherein h1 represents

$$\frac{( B - A )}{A} \times 100 ( \% ) ,$$

where A is an initial weight of the getter composition and B is the weight of the getter composition measured after storing at 25° C. and 60% RH for 500 days; and

h0 represents (CID)×E, assuming 100% reaction of 1 mol of the hygroscopic agent included in the getter composition with water, that is, assuming that 1 mol of the hygroscopic agent included in the getter composition completely reacts with water, wherein C is the amount of moisture absorbed in 1 mol of the hygroscopic agent included in the getter composition, D is the molecular weight of the hygroscopic agent, and E is the content of the hygroscopic agent in the getter composition (wt %).

For example, with regard to h0, in the case where the hygroscopic agent is CaO, the moisture absorption rate upon 100% transformation of CaO+H₂O→Ca(OH)₂ would be 0.32, as calculated from 18(molecular weight of H₂O)/56(molecular weight of CaO)=0.32. Assuming that the content of the hygroscopic agent in the getter composition is E (wt %), the calculated value (h0) of the moisture absorption rate becomes 0.32×E %. If the hygroscopic agent is present in an amount of 30 wt % in the getter composition, the calculated value (h0) of the moisture absorption rate becomes 9.6%.

The getter composition may include a hygroscopic agent and a silicone copolymer having at least one functional group selected from the group consisting of a carboxylic acid group and a polyalkylene oxide group.

(A) Silicone Copolymer having Carboxylic Acid Group and Polyalkylene Oxide Group

The silicone copolymer may have at least one functional group selected from the group consisting of a carboxylic acid group and a polyalkylene oxide group. The silicone copolymer may include a carboxylic acid alone, a polyalkylene oxide group alone, or both the carboxylic acid group and the polyalkylene oxide group.

The term “polyalkylene oxide group” as used herein means “a polyalkylene oxide group, or derivatives thereof”.

The silicone copolymer may include a polysiloxane having at least one functional group selected from the group consisting of a carboxylic acid group and a polyalkylene oxide group.

The carboxylic acid group and the polyalkylene oxide group may be introduced into a side chain or terminal end of the silicone copolymer. Preferably, the carboxylic acid group and the polyalkylene oxide group are introduced into the side chain of the silicone copolymer. When the carboxylic acid group and the polyalkylene oxide group are introduced into the side chain of the silicone copolymer, the getter composition may have a high moisture absorption rate, high moisture absorption capacity, and high dimensional stability under high humidity, and is capable of controlling fluidity during dispensing and vacuum lamination.

The silicone copolymer may be represented by Formula 1, without being limited thereto.

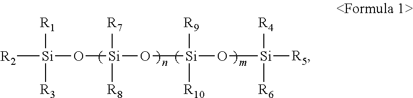

wherein R₁ to R₆ are the same or different and are selected from hydrogen, a hydroxyl group, a carboxylic acid group, a polyalkylene oxide group, a C1-C6 alkyl group, a C2-C6 alkenyl group, a C5-C10 cycloalkyl group, a C5-C10 cycloalkenyl group, a C6-C20 aryl group, or a C7-C20 aralkyl group;

R₇ to R₁₀ are the same or different and are hydrogen; a hydroxyl group; a carboxylic acid group; a polyalkylene oxide group; a C1-C6 alkyl group; a C2-C6 alkenyl group; a C5-C10 cycloalkyl group; a C5-C10 cycloalkenyl group; a C6-C20 aryl group; a C7-C20 aralkyl group; a C1-C6 alkyl group, a C2-C6 alkenyl group, a C5-C10 cycloalkyl group, a C5-C10 cycloalkenyl group, a C6-C20 aryl group, or a C7-C20 aralkyl group having at least one of a carboxylic acid group and a polyalkylene oxide group; or a functional group represented by Formula 2:

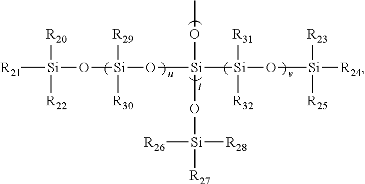

wherein R₂₀ to R₂₈ are the same or different and are selected from hydrogen, a hydroxyl group, a carboxylic acid group, a polyalkylene oxide group, a C1-C6 alkyl group, a C2-C6 alkenyl group, a C5-C10 cycloalkyl group, a C5-C10 cycloalkenyl group, a C6-C20 aryl group, or a C7-C20 aralkyl group;

R₂₉ to R₃₂ are the same or different and are hydrogen; a hydroxyl group; a carboxylic acid group; a polyalkylene oxide group; a C1-C6 alkyl group; a C2-C6 alkenyl group; a C5-C10 cycloalkyl group; a C5-C10 cycloalkenyl group; a C6-C20 aryl group; a C7-C20 aralkyl group; or a C1-C6 alkyl group, a C2-C6 alkenyl group, a C5-C 10 cycloalkyl group, a C5-C 10 cycloalkenyl group, a C6-C20 aryl group, or a C7-C20 aralkyl group having at least one of a carboxylic acid group and a polyalkylene oxide group;

n is 0 to 1000 and m is 0 to 1000, excluding both n and m are zero;

t is 1 to 1000, u is 0 to 500, and v is 0 to 500, excluding both u and v are zero; and

at least one of R₇ to R₁₀ is a carboxylic acid group; a polyalkylene oxide group; a C1-C6 alkyl group, a C2-C6 alkenyl group, a C5-C10 cycloalkyl group, a C5-C 10 cycloalkenyl group, a C6-C20 aryl group, or a C7-C20 aralkyl group having at least one of a carboxylic acid group and a polyalkylene oxide group; or the functional group represented by Formula 2 in which at least one of R₂₉ to R₃₂ is a carboxylic acid group, a polyalkylene oxide group, or a C1-C6 alkyl group, a C2-C6 alkenyl group, a C5-C10 cycloalkyl group, a C5-C10 cycloalkenyl group, a C6-C20 aryl group, or a C7-C20 aralkyl group having at least one of a carboxylic acid group and a polyalkylene oxide group.

The polyalkylene oxide group may represented by Formula 3:

—(—O—(CH₂)ₚ—CH₂—)_{q}—X,

wherein p is an integer ranging from 1 to 5, q is an integer ranging from 1 to 10, and X is hydrogen, a hydroxyl group, a C1-C6 alkyl group, or a C1-C6 alkoxy group.

Preferably, the polyalkylene oxide group is a polyethylene oxide group, or a polypropylene oxide group.

In Formula 3, “—(CH₂)ₚ—” may be a linear or branched alkylene group.

The getter composition may include a mixture of a silicone copolymer (A1) including a carboxylic acid group and a silicone copolymer (A2) including a polyalkylene oxide group. Among (A1)+(A2), the weight ratio of (A2) to (A1) is greater than about 0 and less than or equal to 2, preferably about 0.1 to about 1. Within this range, the getter composition can enhance moisture absorption rate and moisture absorption capacity.

The mixture of (A1) and (A2) is present in an amount of about 20 wt % to about 90 wt %, preferably 30 wt % to 80 wt %. Within this range, the getter composition can have a high moisture absorption rate, high moisture absorption capacity, and high dimensional stability at high temperature and high humidity.

The silicone copolymer has a weight average molecular weight of about 1,000 g/mol or more, preferably about 4,000 g/mol or more, more preferably from about 4,000 g/mol to about 40,000 g/mol, still more preferably from about 7,000 g/mol to about 36,000 g/mol. Within this range, the getter composition may have a high moisture absorption rate, high moisture absorption capacity, and high dimensional stability at high temperature and high humidity.

The silicone copolymer may have a viscosity from about 4,000 cps to 6,000 cps at 25° C. Within this range, the getter composition can maximize moisture absorption capacity upon producing a getter. After producing the getter, the getter does not suffer line disconnection during a dispensing process and can be applied to a substrate with uniform thickness.

The silicone copolymer is present in an amount of about 20 wt % to about 90 wt %, preferably 30 wt % to 80 wt % in the getter composition. Within this range, the getter composition may have a high moisture absorption rate, high moisture absorption capacity, and high dimensional stability at high temperature and high humidity.

The silicone copolymer may be prepared by a typical method or commercially available.

(B) Hygroscopic Agent

The hygroscopic agent may be included in the getter composition together with the silicone copolymer, thereby enhancing moisture absorption rate of the getter composition.

Any hygroscopic agent having excellent moisture adsorption properties may be used. The hygroscopic agent may have a specific surface area of about 10 m²/g to about 100 m²/g, preferably about 40 m²/g to about 100 m²/g. Within this range, the getter composition may have a high moisture absorption rate as well as suitable mechanical properties.

The hygroscopic agent has an average particle diameter of about 5 μm or less, preferably about 0.1 μm to 3 μm. Within this range, the getter composition can be present between substrates into which an organic EL element is deposited in an organic EL display device, thereby providing hygroscopic effects.

The hygroscopic agent may be selected from the group consisting of metal oxides, metal halides, inorganic acid salts of metals, organic acid salts of metals, inorganic phosphorus compounds, porous inorganic compounds, and mixtures thereof.

The hygroscopic agent may be selected from the group consisting of calcium oxide, magnesium oxide, strontium oxide, aluminum oxide, barium oxide, calcium chloride, potassium carbonate, potassium hydroxide, sodium hydroxide, lithium hydroxide, lithium sulfate, sodium sulfate, calcium sulfate, magnesium sulfate, cobalt sulfate, gallium sulfate, titanium sulfate, nickel sulfate, phosphorus pentoxide, nickel sulfate, molecular sieves, and mixtures thereof. Calcium oxide is preferred.

The hygroscopic agent may be used per se, or may be subjected to calcination or calcium hydroxide treatment in a vacuum at high temperature in order to obtain excellent adsorption capabilities. Through calcination, the hygroscopic agent has an enlarged specific surface area, thereby enhancing moisture absorption rate and moisture absorption capacity. Calcination may be achieved by heating the hygroscopic agent to about 200° C. to about 800° C. for about 0.5 to about 24 hours, without being limited thereto.

The hygroscopic agent is present in an amount of about 10 wt % to about 80 wt %, preferably about 9 wt % to about 70 wt %, more preferably about 20 wt % to about 70 wt %. Within this range, the getter composition may have a high moisture absorption rate, high moisture absorption capacity, and high dimensional stability at high temperature and high humidity.

The getter composition may further include a silicone copolymer having an epoxy group. The epoxy group may be present at the side chain or terminal end of the silicone copolymer.

The silicone copolymer having an epoxy group may be represented by Formula 4:

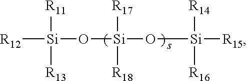

wherein R₁₁ to R₁₆ are the same or different and are selected from hydrogen, a hydroxyl group, a C1-C6 alkyl group, a C2-C6 alkenyl group, a C5-C10 cycloalkyl group, a C5-C10 cycloalkenyl group, a C6-C20 aryl group, or a C7-C20 aralkyl group;

R₁₇ and R₁₈ are the same or different and are hydrogen; an epoxy group; a C1-C6 alkyl group; a C2-C6 alkenyl group; a C5-C10 cycloalkyl group; a C5-C10 cycloalkenyl group; a C6-C20 aryl group; a C7-C20 aralkyl group; or a C1-C6 alkyl group, a C2-C6 alkenyl group, a C5-C10 cycloalkyl group, a C5-C10 cycloalkenyl group, a C6-C20 aryl group, or a C7-C20 aralkyl group having an epoxy group;

at least one of R₁₇ and R₁₈ is an epoxy group; or a C1-C6 alkyl group, a C2-C6 alkenyl group, a C5-C10 cycloalkyl group, a C5-C10 cycloalkenyl group, or a C7-C20 aralkyl group having an epoxy group; and

s is 1 to 1000.

The silicone copolymer having an epoxy group may have a weight average molecular weight of about 4,000 g/mol to about 10,000 g/mol. Within this range, the getter composition may have a high moisture absorption rate, high moisture absorption capacity, and high dimensional stability at high temperature and high humidity.

The silicone copolymer having an epoxy group is optionally present in an amount of about 0 wt % to about 30 wt % in the getter composition. Within this range, the getter composition may have the effect of controlling fluidity and achieving dimensional stability. Preferably, the silicone copolymer is present in an amount of about 1 wt % to about 20 wt %.

The getter composition may be prepared as a slurry by mixing the silicone copolymer with the hygroscopic agent. Mixing may include a process of stirring the silicone copolymer and hygroscopic agent under a nitrogen atmosphere in order to prevent introduction of moisture and oxygen.

The getter composition may be used to produce a getter for large displays (for example, TVs).

The getter composition may be prepared by preparing a silicone polymer, preparing a hygroscopic agent, and mixing the components. The silicone polymer may be used after removing residual moisture and volatile components through heating in a vacuum or in a thin film evaporator.

Another aspect of the present invention provides an organic EL display device including the getter composition. The getter composition may be incorporated into the organic EL display device by a typical method.

The getter in the organic EL display device may be interposed between the substrates constituting an organic EL element or may be attached to a side surface of the organic EL element.

A first substrate is a substrate on which at least one organic EL element is formed. The first substrate may be made of a material, such as transparent glass, plastic sheets, silicone, a metal substrate and the like, and may have flexible or non-flexible properties or transparent or nontransparent properties.

The organic EL element includes a transparent electrode, a hole transport layer, an organic EL layer, and a back electrode.

A second substrate is disposed on the organic EL element to be separated from the first substrate. The second substrate may be attached to the first substrate through an adhesive layer. For the second substrate, any substrate having excellent barrier properties, such as glass substrates, plastic sheets on which metal is laminated, and the like, may be used.

The display device may include large display devices (for example, TVs), without being limited thereto.

### MODE FOR INVENTION

Hereinafter, the invention will be explained in more detail with reference to the following examples. It should be understood that these examples are provided for illustration only and are not to be construed in any way as limiting the invention. Descriptions of details apparent to those skilled in the art will be omitted herein.

### PREPARATIVE EXAMPLE

### Preparation of Silicone Copolymer having Carboxylic Acid Group

77 g of VS200 (di-vinyl polydimethylsiloxane), 23 g of MAA (methacrylic acid) and 0.15 phr of dicumyl peroxide were reacted. After purging with nitrogen, the resulting material was reacted at 80° C. for 4 hours. By adjusting final viscosity to 6,000 cps, a silicone copolymer containing a carboxylic acid group and a molecular weight of 12,000 g/mol was prepared. Residual impurities were removed from the resulting material through washing with toluene and thin film evaporation.

Details of components used in Examples and Comparative Examples are as follows.

(A) Silicone Copolymers:

(A1) Copolymer (Mw: 12,000 g/mol, viscosity: 6,000 cps) prepared in Preparative Example was used as a silicone copolymer having a carboxylic acid group.

(A2) EBP-234 (prepared by Gelest Ltd., Mw: 25,000 g/mol, viscosity: 4,000 cps) was used as a silicone copolymer having a polyalkylene oxide group.

(A3) EMS-622 ((prepared by Gelest Ltd., Mw: 7,000 g/mol) was used as a silicone copolymer having an epoxy group.

(a1) VS2000 (Hanse Chemie) was used as a vinyl silicone polymer (does not include a carboxylic acid group and a polyalkylene oxide group).

(a2) 2:1 weight ratio mixture of CR120/Mod 705 (Hanse Chemie) was used as a Si—H silicone polymer (does not include a carboxylic acid group and a polyalkylene oxide group).

(a3) VQM803 (Hanse Chemie) was used as a VQM silicone polymer (does not include a carboxylic acid group and a polyalkylene oxide group).

(B) Calcined calcium oxide (average diameter 0.5 μm) was crushed and used as a hygroscopic agent.

### Example 1

50 parts by weight of the silicone copolymer (A1) and 50 parts by weight of calcium oxide were mixed using a revolving/rotating mixer under anhydrous conditions and a high purity nitrogen atmosphere, followed by dispersing the mixture three times in succession using a 3-roll mill to prepare a getter composition. The prepared composition had a viscosity of 15,000 cps at 25° C. and 5 rpm. The viscosity was measured by a Brookfield viscometer DV-II+ using a No. 52 spindle and a Corn & Plate type Jig.

### Example 2

A getter composition was prepared in the same manner as in Example 1 except that 50 parts by weight of silicone copolymer (A2) was used instead of the silicone copolymer (A1).

### Example 3

A getter composition was prepared in the same manner as in Example 1 except that 25 parts by weight of the silicone copolymer (A1) and 25 parts by weight of the silicone copolymer (A2) were used instead of the silicone copolymer (A1).

### Example 4

A getter composition was prepared in the same manner as in Example 1 except that 25 parts by weight of silicone copolymer (A1) and 25 parts by weight of the silicone copolymer (A3) were used instead of the silicone copolymer (A1).

### Comparative Examples 1-3

Getter compositions were prepared in the same manner as in Example 1 except that 50 parts by weight of the silicone copolymer (a1), (a2) or (a3), and 200 ppm of platinum catalyst (Catalyst 520, Hanse) were used instead of the silicone copolymer (A1).

The components of the getter compositions prepared in Examples 1-4 and Comparative Examples 1-3 are summarized in Table 1.

TABLE 1

| | | Example | | | | Comparative Example | | |
|---|---|---|---|---|---|---|---|---|
| | | 1 | 2 | 3 | 4 | 1 | 2 | 3 |
| Silicone | (A1) | 50 | — | 25 | 25 | — | — | — |
| copolymer | (A2) | — | 50 | 25 | — | — | — | — |
| | (A3) | — | — | — | 25 | — | — | — |
| | (a1) | — | — | — | — | 41 | — | 21 |
| | (a2) | — | — | — | — | 9 | 9 | 9 |
| | (a3) | — | — | — | — | — | 41 | 20 |

| | | | | | | | |
|---|---|---|---|---|---|---|---|
| Hygroscopic agent | 50 | 50 | 50 | 50 | 50 | 50 | 50 |
| Catalyst | — | — | — | — | 200 ppm | 200 ppm | 200 ppm |
| Viscosity (25° C., cps) | 15000 | 14000 | 10000 | 13000 | 13000 | 16000 | 14000 |

Physical properties of the getter compositions prepared in Examples and Comparative Examples were evaluated and results are shown in Table 2.

(1) Moisture absorption rate: The initial weight (A) of the getter composition was measured. After storing the getter composition at 25° C. and 60% RH for 500 days, the weight (B) of the getter composition was measured. Moisture absorption rate was calculated according to Equation 1.

(2) Difference between measured moisture absorption rate and calculated moisture absorption rate: Measured value of moisture absorption rate was calculated in accordance with (1). Calculated value of moisture absorption rate was calculated by Equation 2. Assuming that reaction of CaO+H₂O→Ca(OH)₂ was completely performed, the calculated moisture absorption rate was 0.32, as calculated from 18 (molecular weight of H₂O)/56 (molecular weight of CaO)=0.32. Since the content of CaO in the liquid state getter was 50 wt %, the calculated moisture absorption rate became 16%. From these values, the difference between the measured moisture absorption rate and the calculated moisture absorption rate was determined.

(3) Moisture absorption rate: The initial weight (A) of a getter composition was measured. After storing the getter composition at 25° C. and 60% relative humidity for 24 hours, the weight (C) of the getter composition was measured. Moisture absorption rate was calculated from ((C-A)/A×100%)/Time.

(4) Applicability of dispensing process: An OLED was mounted on a substrate. A syringe fitted with Φ0.4 mm (inner diameter) needle was filled with a getter composition. When the composition was dispensed at 0.5 MPa, it was observed whether the composition was dispensed to uniform thickness without disconnecting the line of the getter. When discharge was performed smoothly and the composition was dispensed maintaining uniform width without disconnecting the line, it was evaluated as ⊚; when discharge was performed maintaining uniform width but the liquid was not disconnected after writing, it was evaluated as ο, and when discharge was performed but width was not uniform and collapse or disconnected occasionally, it was evaluated as Δ; and when even discharge was not performed, it was evaluated as X.

(5) Applicability of vacuum lamination: An OLED was mounted on a substrate. A syringe fitted with Φ0.4 mm (inner diameter) needle was filled with a getter composition. The composition was dispensed at 0.5 MPa. A liquid state sealant (prepared by Nagase Ltd.) was dispensed onto a flat glass, followed by laminating under a pressure of 10⁻² torr. When the getter was not dripped on the organic EL element and was not suctioned into the element and phase separation did not occur, it was evaluated as ⊚; when the getter was not dripped on the organic EL element and was not suctioned into the element and slight phase separation occurred, it was evaluated as ο; and when the getter was not dripped on the organic EL element and was a little suctioned into the organic EL element, it was evaluated as Δ; and when the getter was dripped on the organic EL element or line was disconnected, it was evaluated as X.

(6) OLED property after curing: An OLED was mounted on a substrate. A syringe fitted with Φ0.4 mm (inner diameter) needle was filled with a getter composition. The composition was dispensed at 0.5 MPa. A liquid state sealant (Nagase Ltd.) was dispensed on a flat glass sheet, followed by laminating under a pressure of 10⁻² torr. After UV curing, OLED properties were evaluated on a cell subjected to aging at 100° C. for 30 minutes. When the OLED emitted light without dark spots, it was evaluated as ο; when an area ratio of minute dark spots was less than 50%, it was evaluated as Δ; and when an area ratio of dark spots was 50% or more, it was evaluated as X.

(7) OLED reliability: An OLED prepared in accordance with (6) was stored at 85° C. and 85% RH for 500 hours, whether occurrence of dark spots and the presence of defects in the OLED were evaluated. When the OLED emitted light without dark spots, it was evaluated as ο; when an area ratio of minute dark spots was less than 50%, it was evaluated as Δ and when an area ratio of dark spots was 50% or more, it was evaluated as X.

TABLE 2

| | Example | | | | Comparative Example | | |
|---|---|---|---|---|---|---|---|
| | 1 | 2 | 3 | 4 | 1 | 2 | 3 |
| Measured value | 18 | 17 | 17.3 | 17.2 | 9.7 | 11.2 | 10.8 |
| of moisture | | | | | | | |
| absorption rate (%) | | | | | | | |
| Calculated value | 16 | 16 | 16 | 16 | 16 | 16 | 16 |
| of moisture | | | | | | | |
| absorption rate (%) | | | | | | | |
| Difference between | 2 | 1 | 1.3 | 1.2 | −6.3 | −4.8 | −5.2 |
| measured value of | | | | | | | |
| moisture absorption | | | | | | | |
| rate and calculated | | | | | | | |
| value of moisture | | | | | | | |
| absorption rate (%) | | | | | | | |
| Moisture absorption | 0.4 | 0.6 | 0.5 | 0.5 | 0.05 | 0.1 | 0.08 |
| rate (%//time) | | | | | | | |
| Dispensing | ◯ | ◯ | ⊚ | ◯ | ◯ | ◯ | ◯ |
| Vacuum lamination | ◯ | ◯ | ◯ | ◯ | Δ | Δ | Δ |
| OLED after curing | ◯ | ◯ | ◯ | ◯ | X | ◯ | Δ |
| OLED reliability | ◯ | ◯ | ◯ | ◯ | X | Δ | X |

As shown in Table 2, the getter composition according to the present invention has a high moisture absorption rate, high moisture absorption capacity, and high dimensional stability at high temperature and high humidity. Further, the getter composition according to the present invention is able to control fluidity during the dispensing and vacuum lamination processes, causes no dark spot upon application to organic devices, and is capable of providing OLEDs having high reliability at high temperature and high humidity.

Although some embodiments have been described herein, it will be understood by those skilled in the art that these embodiments are provided for illustration only, and various modifications, changes, alterations and equivalent embodiments can be made without departing from the scope of the present invention. Therefore, the scope and sprit of the present invention should be defined only by the accompanying claims and equivalents thereof.

1. A getter composition comprising: a silicone copolymer having at least one functional group selected from the group consisting of a carboxylic acid group and a polyalkylene oxide group, and a hygroscopic agent.

2. The getter composition according to claim 1, wherein the functional group is introduced into a side chain of the silicone copolymer.

3. The getter composition according to claim 1, wherein the silicone copolymer has a weight average molecular weight of about 1,000 g/mol or more.

4. The getter composition according to claim 1, wherein the silicone copolymer has a structure represented by Formula 1: 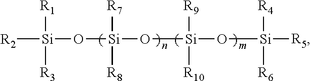
wherein R₁ to R₆ are the same or different and are selected from hydrogen, a hydroxyl group, a carboxylic acid group, a polyalkylene oxide group, a Cl -C6 alkyl group, a C2-C6 alkenyl group, a C5-C10 cycloalkyl group, a C5-C10 cycloalkenyl group, a C6-C20 aryl group, or a C7-C20 aralkyl group;
R₇ to R₁₀ are the same or different and are hydrogen; a hydroxyl group; a carboxylic acid group; a polyalkylene oxide group; a C1-C6 alkyl group; a C2-C6 alkenyl group; a C5-C10 cycloalkyl group; a C5-C10 cycloalkenyl group; a C6-C20 aryl group; a C7-C20 aralkyl group; a group, a C6-C20 aryl group, or a C7-C20 aralkyl group having at least one of a carboxylic acid group and a polyalkylene oxide group; or a functional group represented by Formula (2): 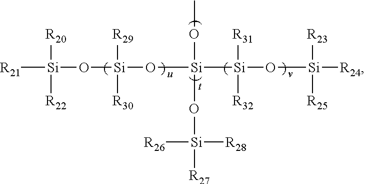
wherein R₂₀ to R₂₈ are the same or different and are selected from hydrogen, a hydroxyl group, a carboxylic acid group, a polyalkylene oxide group, a C1-C6 alkyl group, a C2-C6 alkenyl group, a C5-C10 cycloalkyl group, a C5-C10 cycloalkenyl group, a C6-C20 aryl group, or a C7-C20 aralkyl group;
R₂₉ to R₃₂ are the same or different and are hydrogen; a hydroxyl group; a carboxylic acid group; a polyalkylene oxide group; a C1-C6 alkyl group; a C2-C6 alkenyl group; a C5-C10 cycloalkyl group; a C5-C10 cycloalkenyl group; a C6-C20 aryl group; a C7-C20 aralkyl group; or a C1-C6 alkyl group, a C2-C6 alkenyl group, a C5-C10 cycloalkyl group, a C5-C10 cycloalkenyl group, a C6-C20 aryl group, or a C7-C20 aralkyl group having at least one of a carboxylic acid group and a polyalkylene oxide group;
t is 1 to 1000, u is 0 to 500, and v is 0 to 500, excluding both u and v are zero;
at least one of R₇ to R₁₀ is a carboxylic acid group; a polyalkylene oxide group; a C1-C6 alkyl group, a C2-C6 alkenyl group, a C5-C10 cycloalkyl group, a C5-C10 cycloalkenyl group, a C6-C20 aryl group, or a C7-C20 aralkyl group having at least one of a carboxylic acid group and a polyalkylene oxide group; or the functional group represented by Formula 2 in which at least one of R₂₉ to R₃₂ is a carboxylic acid group, a polyalkylene oxide group, or a C1-C6 alkyl group, a C2-C6 alkenyl group, a C5-C10 cycloalkyl group, a C5-C10 cycloalkenyl group, a C6-C20 aryl group, or a C7-C20 aralkyl group having at least one of a carboxylic acid group and a polyalkylene oxide group; and
n is 0 to 1000 and m is 0 to 1000, excluding both n and m are zero.

5. The getter composition according to claim 1, comprising: a mixture of a silicone copolymer (A1) comprising a carboxylic acid group and a silicone copolymer (A2) comprising a polyalkylene oxide group.

6. The getter composition according to claim 5, wherein a weight ratio (A2/A1) of (A2) to (A1) is greater than about 0 and less than or equal to 2.

7. The getter composition according claim 1, wherein the hygroscopic agent has an average particle diameter of about 0.1 μm to about 5 μm.

8. The getter composition according to claim 1, wherein the hygroscopic agent is selected from the group consisting of calcium oxide, magnesium oxide, strontium oxide, aluminum oxide, barium oxide, calcium chloride, potassium carbonate, potassium hydroxide, sodium hydroxide, lithium hydroxide, lithium sulfate, sodium sulfate, calcium sulfate, magnesium sulfate, cobalt sulfate, gallium sulfate, titanium sulfate, nickel sulfate, phosphorus pentoxide, nickel sulfate, molecular sieves, and mixtures thereof.

9. The getter composition according to claim 1, comprising: about 20 wt % to about 90 wt % of the silicone copolymer and about 10 wt to about 80 wt % of the hygroscopic agent.

10. The getter composition according to claim 1, further comprising: a silicone copolymer having an epoxy group.

11. The getter composition according to claim 10, wherein the silicone copolymer having an epoxy group is represented by Formula 4: 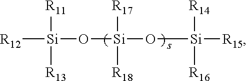
wherein R₁₁ to R₁₆ are the same or different and are selected from hydrogen, a hydroxyl group., a C1-C6 alkyl group, a C2-C6 alkenyl group, a C5-C10 cycloalkyl group, a C5-C10 cycloalkenyl group, a C6-C20 aryl group, or a C7-C20 aralkyl group;
R₁₇ and R₁₈ are the same or different and are hydrogen; an epoxy group; a C1-C6 alkyl group; a C2-C6 alkenyl group; a C5-C10 cycloalkyl group; a C5-C10 cycloalkenyl group; a C6-C20 aryl group; a C7-C20 aralkyl group; or a C1-C6 alkyl group, a C2-C6 alkenyl group, a C5-C10 cycloalkyl group, a C5-C10 cycloalkenyl group, a C6-C20 aryl group, or a C7-C20 aralkyl group having an epoxy group;
at least one of R₁₇ and R₁₈ is an epoxy group; or a C1-C6 alkyl group, a C2-C6 alkenyl group, a C5-C10 cycloalkyl group, a C5-C10 cycloalkenyl group, or a C7-C20 aralkyl group having an epoxy group; and
s is 1 to 1000.

12. The getter composition according to claim 1, wherein the composition is a non-curable composition.

13. The getter composition according to claim 1, wherein the composition has a moisture absorption rate of about 10% or more as calculated by Equation 1:
$$Moisture absorption rate ( \% ) = \frac{( B - A )}{A} \times 100 ,$$
wherein A is an initial weight of the getter composition and B is a weight of the getter composition measured after storing at 25° C. and 60% relative humidity for 500 days.

14. The getter composition according to claim 1, wherein the composition has a difference in moisture absorption rate (h1−ho) of about 1% or more, which is a difference between a measured value (h1) of moisture absorption rate and a calculated value (h0) of moisture absorption rate, as calculated by Equation 2: Difference in moisture absorption rate=h1−h0,
wherein h1 represents
$$\frac{( B - A )}{A} \times 100 ( \% ) ,$$
where A is an initial weight of the getter composition, and B is a weight of the getter composition measured after storing at 25° C. and 60% relative humidity for 500 days; and
h0 represents (CID)×E, assuming 100% reaction of 1 mol of the hygroscopic agent included in the getter composition with water, where C is the amount of moisture absorbed in 1 mol of the hygroscopic agent included in the getter composition, D is a molecular weight of the hygroscopic agent, and E is the content of the hygroscopic agent included in the getter composition (wt %).

15. The getter composition according to claim 1, wherein the composition has a viscosity at 25° C. from about 5,000 cps to about 20,000 cps.

16. A display device comprising the getter composition according to claim 1.
